(19) United States
(12) Patent Application Publication
(10) Pub. No.: US 2011/0097051 A1
(43) Pub. Date: Apr. 28, 2011

(54) OPTICAL FIBRE ORGANISER TRAY WITH BIASING MEANS

(75) Inventors: Pieter Vermeulen, Tielt Winge (BE); Pieter Arthur Anna De Vos, Berchem (BE); Barbara Maria Willems, Heverlee (BE)

(73) Assignee: Tyco Electronics Raychem BVBA, Kessel-Lo (BE)

(21) Appl. No.: 12/737,348

(22) PCT Filed: Jun. 30, 2009
(86) PCT No.: PCT/GB2009/050758

§ 371 Date: Jan. 3, 2011

(30) Foreign Application Priority Data
Jul. 4, 2008 (GB) 0812266.5

(51) Int. Cl. G02B 6/46

(52) U.S. Cl. 385/135

(57) ABSTRACT

An optical fibre organiser tray (12) especially a splice tray, movable between a storage position and an access position, in which there are provided resilient biasing means (60, 61) operable to urge the organiser tray to adopt one of at least two stable states one being the said storage position and the other being the said access position.

The present invention relates generally to an optical fibre organiser tray and particularly, but not exclusively, to an organiser tray which may be fitted with optical fibre connectors for use as a connector tray, or which may be used simply as a storage tray to store one or more lengths of optical fibre. The present invention also extends to the provision of a resilient biasing and guide member for guiding an optical fibre to or away from an organiser tray and for biasing the organiser tray towards a storage position or an access position.

In a fibre optical network, optical fibres are typically routed from a central office on a service provider via optical fibre distribution and organisation devices by means of which bundles of optical fibres are successively split up to allow individual fibres to be routed to their ultimate destinations. Within the central office there is a very large number of optical fibres to be organised, and this organisation is undertaken in distribution cabinets, frames, boxes and other organiser devices, which may be provided with banks or arrays of individual organiser trays. Such organiser trays, especially if provided with optical fibre connectors for making so-called “splice” connections are, for reasons of minimising the space occupied, arranged in arrays which may be in the form of a stack of organiser trays one above the other from which individual organiser trays can be displaced to an access position to allow an operator to work on the connections.

The present invention seeks to provide an optical fibre organiser tray which can be stacked in an array of such trays one above the other and which has guide means and resilient biasing means allowing it to be moved between a storage position and an access position and held stably in each position.

When the organiser tray is withdrawn to its access position so that an operator can either make or change a connection, for example a splice connection, of fibres carried by the tray, it is important that the tray is located stably in position so that the connection operations are not compromised by any slackness in the location of the tray or any movement which may occur if the tray is not located firmly in position. If a simple drawer-type system of organiser trays is used there is also a risk that the organiser tray may be inadvertently displaced back to its storage position during a connection operation, which makes it difficult for the operator to complete the connection properly and potentially disruptive of the connection being made.

The present invention seeks to provide an optical fibre organiser tray, which will be movable between storage and access positions and located securely in position with no risk of inadvertent displacement during connection operations when in the access position and also a resilient guide arm for such an organiser tray, which will provide secure guidance and protection for optical fibres leading to and from the organiser tray against infringement of the minimum bend radius condition which also has the beneficial effect of minimising the requirement for excess fibre length which in prior art such systems have been provided in order not to put strain on the optical fibres when an organiser tray is moved to its access position.

It should be understood that the present invention extends to include an optical fibre organiser tray having connectors making it suitable for use as a connector tray which may be fitted with any kind of optical fibre connectors, such as splicers, splitters, aligned optical lens devices, tap-off connections, etc. In a splicing tray it is common to provide excess fibre length to allow subsequent splices to be made if the connection made by the original splice should need to be changed at some stage in the future.

According to a first aspect of the present invention, therefore, an optical fibre organiser tray movable between a storage position and an access position is provided with resilient biasing means operable to urge the organiser tray to adopt one of at least two stable states one being the said storage position and the other being the said access position.

In a preferred embodiment of the invention the said resilient biasing means also acts, at least in part, as a guide for guiding the movement of the organiser tray between the said storage position and the said access position.

Although a number of different mechanical arrangements are possible to meet this condition, it is found to be particularly beneficial if the said resilient biasing means comprise one or more resilient elements extending between the said organiser tray and a fixed support therefor, and having a position of maximum stress when the organiser tray is located at an intermediate point between the said storage position and the said access position. Such a tray preferably has a two-state or bistable configuration, although arrangements with more than two such stable states are envisaged.

It is particularly convenient if the or each said resilient element is a curved flexible strip extending between the said fixed support and the organiser tray in an arrangement such that the curvature of the strip is least at the said storage and access positions and increases as the tray moves towards the said intermediate point.

In embodiments of the invention there may be two such resilient biasing strips extending on respective opposite sides of the tray. This then provides both guidance for the translation movement of the tray and biasing towards each of the two end positions of its movement.

One particularly convenient configuration for such a resilient biasing strip is one having a reflex curvature.

Although the present invention can be put into practice using organiser trays which are displaceable in a curved path between the storage and access positions, and even trays which are turnable about an axis between these two positions, it is particularly convenient for the trays to be made having a substantially rectilinear displacement path between the storage and access positions, in which case there may also be provided linear guide means for guiding the organiser tray to follow a substantially linear path between the storage and access positions.

Such linear guide means may comprise cooperating guide members on the organiser tray and at least one adjacent such organiser tray. In other words, guidance of each individual organiser tray is provided by its neighbour or neighbours, so that no separate fixed guide structure is required for a stack of organiser trays since the stack itself provides the guidance for movement of an organiser tray between its storage and access positions. Normally only one or two such organiser trays are required to be moved from the storage to the access position at any one time.

In one embodiment of the invention the organiser trays are intended to be stacked in an array of trays one above the other, in which case the cooperating guide means may comprise a first guide member projecting rearwardly of the organiser tray and shaped to engage with a cooperating second guide member on an adjacent organiser tray as the said organiser tray is drawn out from its storage position towards its access position.

If the organiser trays are splice trays having a generally planar conformation, guides in the base of the tray for receiving cooperating guides in a rearwardly and upwardly projecting arm are particularly convenient.

In a preferred embodiment of the invention the said cooperating guide means of an organiser tray further comprise a third guide member shaped to engage with the said second guide member on the said adjacent organiser tray as the said adjacent organiser tray is drawn out towards its access position.

Not only may the curved flexible strip constituting the biasing and guiding means act to control the position of the organiser tray, but this strip may also be provided with means for receiving and supporting optical fibres. Such means may be in the form of hook-shape projections extending laterally of the strip on at least one side thereof which can act to receive and retain optical fibres closely against the strip such that the fibres will follow the reflex curvature of the strip and be limited to the curvature which the strip can adopt. This has the advantage that no overlength of optical fibre is needed to allow the movement of the tray between its two end positions. The strip may be made of any suitable material, such as plastics, rubber, or metal, and its resilience may vary along its length, for example by thickness variation, changes in cross section or other means (reinforcement with other materials or variation in consistency for example).

In another aspect the present invention provides an optical fibre organiser tray, such as a splice tray, intended to be stacked with other such trays one above the other, and to be movable linearly between a storage position and an access position, in which there are provided guide means on the tray for engagement with cooperating guide means on at least one adjacent such tray whereby to guide the tray in its linear movement between the said two positions.

The present invention also comprehends a guide strip for use in guiding an organiser tray between a storage and an access position, the guide strip having means for receiving and supporting an optical fibre and being arranged to have two stable positions to which it can move as it guides and urges the organiser tray between a storage and an access position.

The present invention also comprehends an optical fibre organiser tray having guide means which comprise a first guide member projecting rearwardly of the tray and engageable with a cooperating second guide member on an adjacent tray upon displacement of the said tray from a storage position towards an access position.

The said cooperating guide means may further comprise a third guide member adapted to engage the said second guide member on the said adjacent tray as the said adjacent tray is drawn out towards its access position.

One embodiment of the present invention will now be more particularly described, by way of example, with reference to the accompanying drawings, in which:

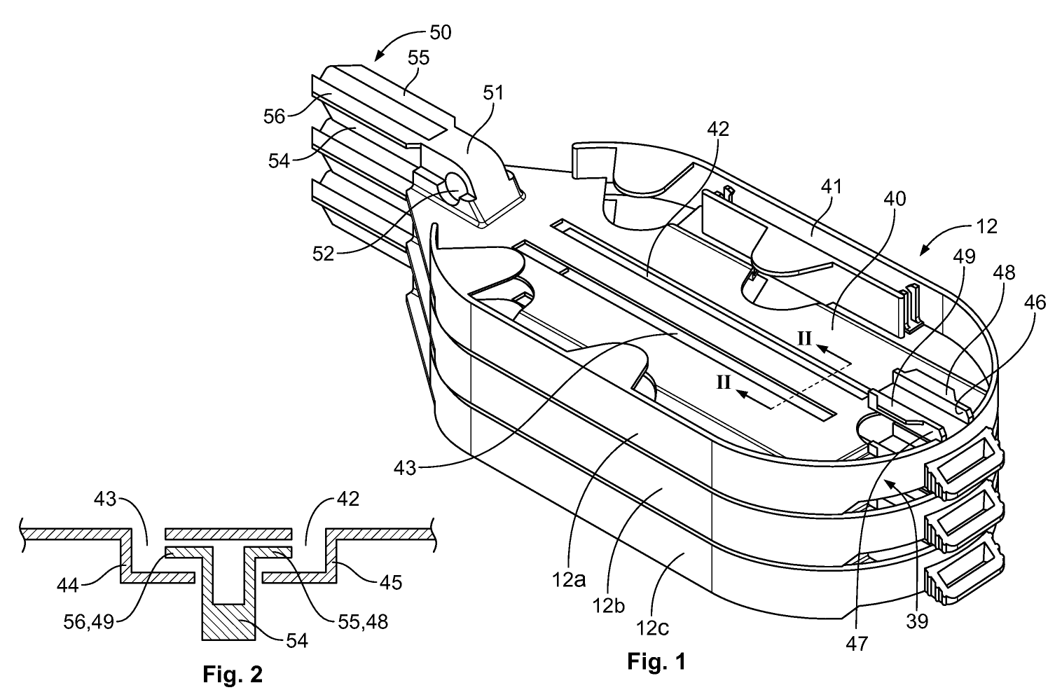

FIG. 1 is a perspective view of a set of three organiser trays of the invention shown in a storage position;

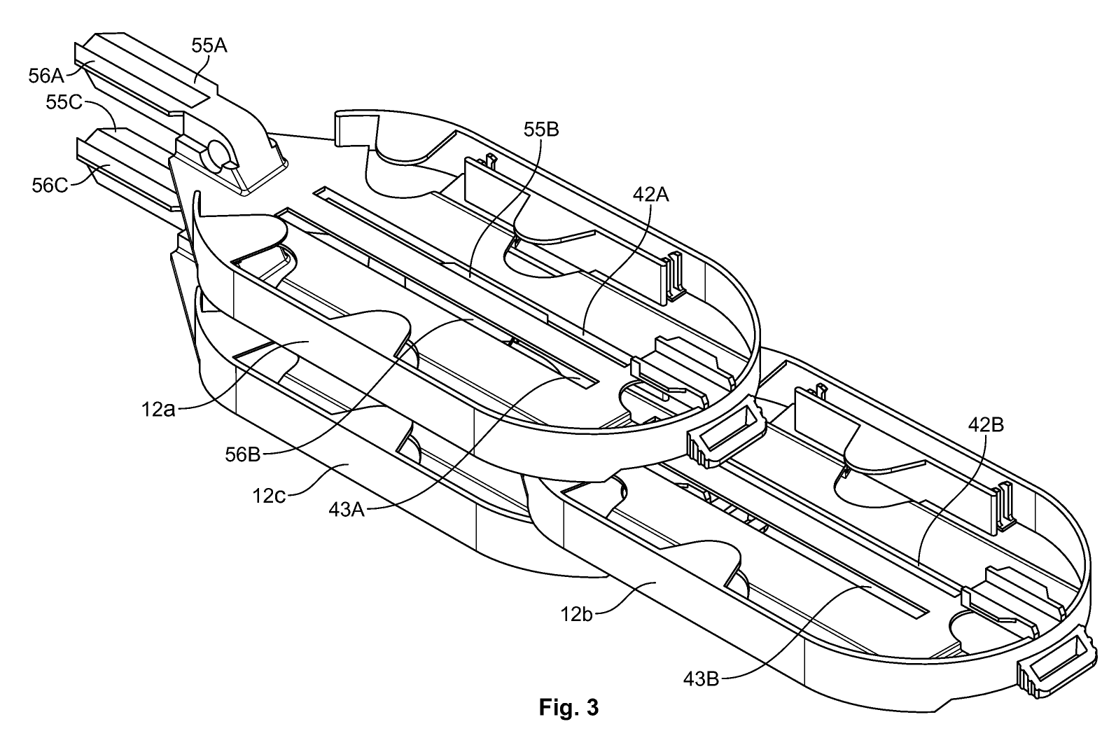

FIG. 2 is a scrap sectional view taken on the line II-II of FIG. 1;

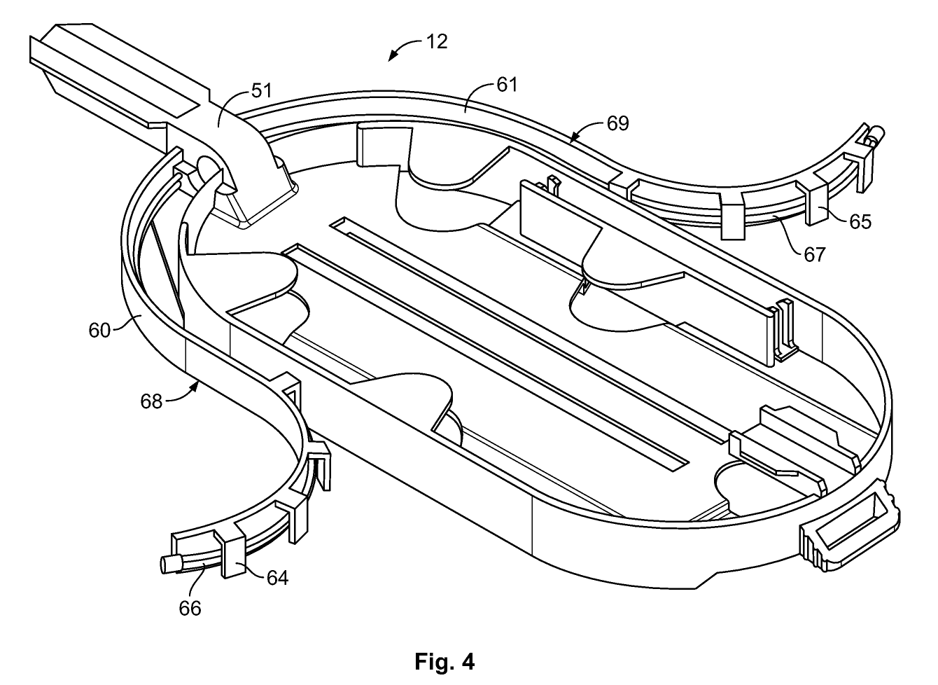

FIG. 3 is a perspective view similar to that of FIG. 1, showing one of the organiser trays partly withdrawn towards its access position;

FIG. 4 is a perspective view of an individual organiser tray illustrating the guide arms which resiliently bias its movement, shown in a retracted or storage condition;

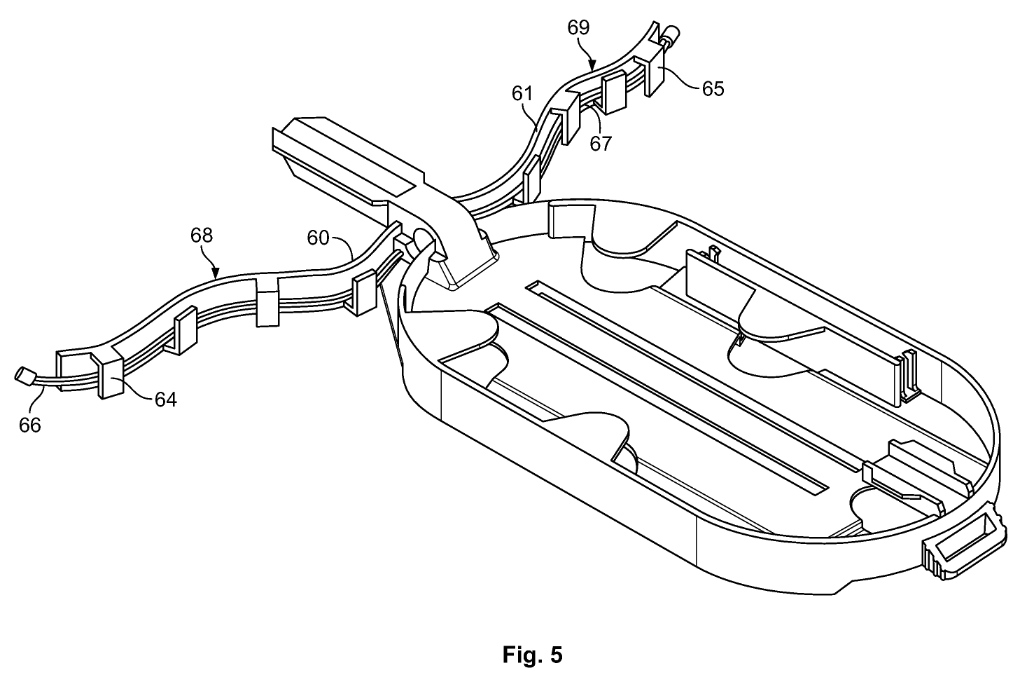

FIG. 5 is a perspective view of an individual organiser tray, similar to that of FIG. 4, but shown in the access condition; and

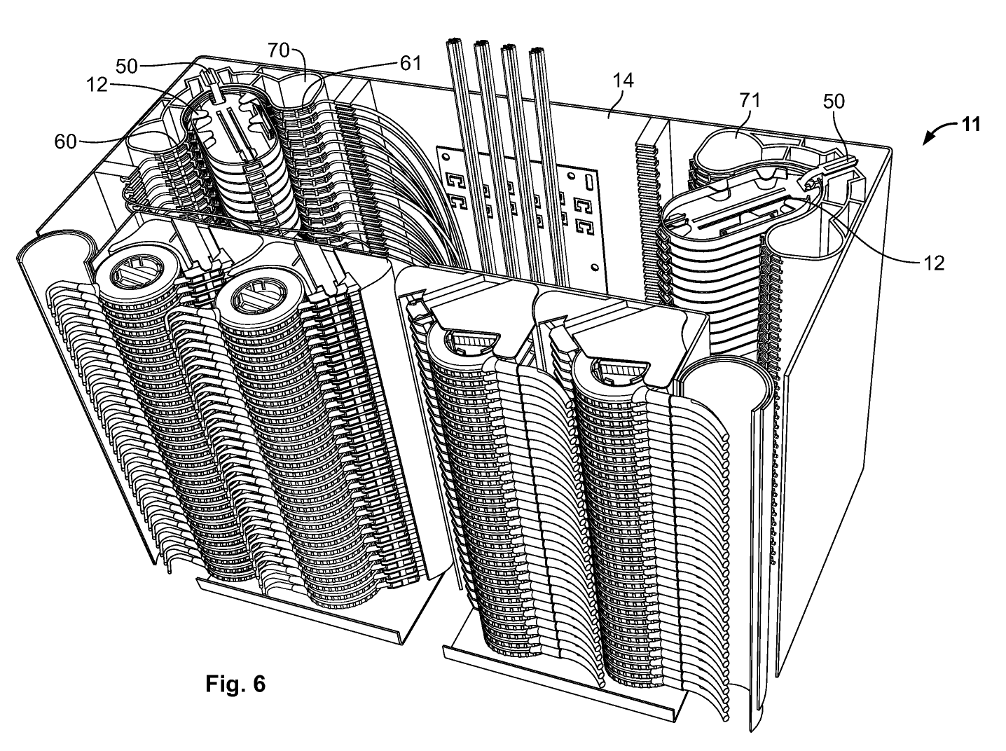

FIG. 6 is a perspective view of an optical fibre organiser in which the tray of the invention may be used.

Referring now to the drawings, each optical fibre organiser tray 12 comprises a floor 40 of generally oval shape, that is a rectangle with semi-circular ends, surrounded by an upstanding peripheral wall 41 defining a shallow tray, in this embodiment a splice tray, within which are located fibre guides and mounts for splices, which are not shown as they do not form part of this invention. The fibre guides and splicers may be of conventional or unconventional type, including splitters, doublers and other fibre connecting devices such as aligned optical lens devices, tap-off connections etc.

As can be seen from the drawings, the splice trays 12 are intended to be fitted together and used in modular arrays of, say, four, eight, twelve or more trays fitted into banks of organiser trays within an optical fibre distribution organiser frame. For this purpose the floor 40 of each tray 12 is provided with two longitudinal slots 42, 43 parallel to the length of the tray beneath which are defined two parallel longitudinal downwardly depending longitudinal guides 44, 45 of L-shape cross section. At the front end 39 of the tray 12 are two upstanding flanges 46, 47 from which project lateral tabs 48, 49 which are spaced by a distance such that the tabs 48, 49 of one tray 12 fit into the elbow defined by the L-section guides 44, 45 of an overlying tray 12 when it is drawn forward from the stacked or storage position illustrated in FIG. 1 towards the advanced or access position shown in FIG. 3.

Further guidance for the movement of a tray 12 is provided by a rearwardly extending guide arm 50. The arm 50 has a root portion 51 upstanding from the floor 40 of the splice tray 12 and a rearwardly projecting guide limb 54 from the upper edge of which project two longitudinally extending lateral guide fins 55, 56 which, as will be appreciated from FIG. 3 and FIG. 2, engage into the elbows of the longitudinal guide rails 44, 45 which project downwardly from the floor of the overlying splice tray 12, when the tray in question is drawn forward towards its access position. The guide fins 55B and 56B of the middle tray 12B, engage the flanges of 46A, 47A of the upper tray 12A and at the same time the lateral tabs 48C, 49C of the lower tray 12C engage with the flanges 46B, 47B of the middle tray 12B when the middle tray 12B is drawn. FIGS. 1 and 3 the three trays 12 shown are identified 12A, 12B and 12C and all the relative constituent parts described herein are therefore correspondingly identified with the same letters A, B and C. As will be seen, therefore, in FIG. 3 the guide fins 55B, 56B of the tray 12B, which is shown drawn forward towards its access position, are engaged within the slots defined by the elbows of the guides 44A, 45A projecting down from the slots 42A, 43A in the upper of the three splice trays 12 illustrated. In the position shown in FIG. 3, therefore, the tray 12B is securely guided in its rectilinear travel by the fins 55B, 56B in the guides 44A, 45A at the rear of the tray 12B, whilst, the tabs 48C, 49C of the underlying splice tray 12C engage onto the elbows of the guides 44B, 45B beneath the slots 42B, 43B of the splice tray 12B.

Secured to the tray 12 (see FIG. 4) close to the root portion 51 of the rearwardly extending guide arm 50 are two laterally projecting resiliently flexible guide and biasing strips 60, 61 each of which has a reflex curvature and the end of each of which remote from the tray 12 is held in position on a fixed support of an optical distribution frame in which the stack of trays 12 is located in use. In practice, of course, the two strips 60, 61 could be formed integrally as one strip having a double reflex curve with its intermediate or bight portion secured to the rear of the tray 12 and its free ends connected to the fixed support, or may be made integrally with the tray itself

The resiliently flexible strips 60, 61 have a flat leaf spring-like configuration with projecting hook shape retainers 64, 65 spaced along their length for engaging and retaining optical fibres 66, 67 leading into the splice tray 12 to be spliced therein by the splicing means (not shown).

As a tray 12 is drawn from the storage position illustrated in FIGS. 1 and 4 towards its access position shown in FIGS. 3 and 5 the resiliently flexible strips 60, 61 are caused to “roll” in a manner similar to a rolling seal, increasing the curvature of the intermediate portions 68, 69 thereof as they pass through a mid-point in the travel. Thereafter, further advancing movement of the tray 12 causes a relative straightening of the strip portions 68, 69 to reach a stable position as shown in FIG. 5, in which the strips hold the tray 12B in its fully advanced access position. This is illustrated schematically in FIG. 5 from which it can be seen that whilst an operator is working on the tray 12 to make or adapt any splicing connections thereon, the resilient strips 60, 61 hold the tray securely in the advanced position so that any forces applied to the tray by the operator in making the splice connections do not cause the tray to move back towards its storage position.

When the splice connections are complete, however, a firm pressure on the front end 39 of the tray 12 will cause the resilient strips 60, 61 to flex (at the portions 68, 69) back through their maximum-stress position until, having passed this position they spring back towards the storage position illustrated in FIG. 4 holding the tray 12 firmly in this position. In this movement the tray will not be likely to get stuck in an intermediate position which would hinder the operator during routing of the fibres, and due to the stress in the strips when the tray is in the advanced position it will not be likely to be pushed back accidentally during manipulation of the fibres.

FIG. 6 illustrates how the splice trays 12 are stacked in an optical fibre distribution frame generally indicated 11, in an inclined orientation such that the arms 50 lie at 45° to the back wall 14 of the frame 11. The guide strips 60, 61 are held on shaped columnar formers 70, 71 the curved faces of which help to hold the shape of the strips 60, 61 in the storage position.

It is an advantage of this configuration that the fixed length of the strips 60, 61 which carry the fibres 66, 67 means that the fibre 66, 67 itself is of the same length and therefore no excess fibre is needed for allowing slack to accommodate the forward and reverse movement of the tray 12. Moreover, by locating the strips 60, 61 at the rear of the tray they can perform their combined support and biasing function without obstructing the working space needed by an operator when making or changing splices. Although described herein as separate components it will be understood that the strips 60, 61 could be made as a single element or even integrally moulded with the tray to form a one-part component with it.

It will be appreciated that the inter-engagement of the flanges and slots which define the guidance system between adjacent trays 12 means that a minimum amount of space outside the trays 12 is needed for the guidance mechanism.

The resilient guide strips 60, 61 also provide protection for the fibres guaranteeing that the minimum bend radius of the fibre will not be exceeded, thereby reducing the chance of optical losses. The guidance system is compact and the protection to the fibres 66, 67 offered by the arms 60, 61 means that no protective cladding or “over tubing” is required to protect the fibres. Moreover, it will be appreciated that the guide elements which direct the movement of the tray are located close to the axis of rectilinear movement of the tray thereby obtaining a high level of stability and robustness.

1. An optical fibre organiser tray especially a splice tray, movable between a storage position and an access position, in which there are provided resilient biasing means operable to urge the organiser tray to adopt one of at least two stable states one being the said storage position and the other being the said access position.

2. An optical fibre organiser tray as claimed in claim 1, in which the said resilient biasing means also acts, at least in part, as a guide for guiding the movement of the organiser tray between the said storage position and the said access position.

3. An optical fibre organiser tray as claimed in claim 1 OF claim 2, in which the said resilient biasing means comprise one or more resilient elements extending between the said organiser tray and a fixed support therefor, and having a position of maximum stress when the organiser tray is located at an intermediate position between the said storage position and the said access position.

4. An optical fibre organiser tray as claimed in claim 3, in which the or each said resilient element is a curved flexible elongate strip extending between the said fixed support and the organiser tray in an arrangement such that the curvature of the strip is least at the said storage and access positions and increases as the organiser tray moves towards the said intermediate position.

5. An optical fibre organiser tray as claimed in claim 4, in which there are two such elongate flexible strips or two portions of a monolithic single such strip extending on respective opposite sides of the tray.

6. An optical fibre organiser tray as claimed in claim 4, in which the or each said elongate flexible strip has a reflex curvature.

7. An optical fibre organiser tray as claimed in claim 1, in which there are provided linear guide means for guiding the organiser tray to follow a substantially linear path between the said storage and access positions.

8. An optical fibre organiser tray as claimed in claim 7, in which the said linear guide means comprise co-operating guide members on opposite faces of the organiser tray such that two such organiser trays are able to interengage one another for mutual guidance.

9. An optical fibre organiser tray as claimed in claims 8, intended to be stacked in an array of such trays one above the other, in which the said cooperating guide members act between a tray and its next adjacent neighbour or neighbours.

10. An optical fibre organiser tray as claimed in claim 9, in which the said co-operating guide means comprise a first guide member projecting rearwardly of the organiser tray and shaped to engage with a cooperating second guide member on an adjacent organiser tray as the said organiser tray is drawn out from its storage position towards its access position.

11. An optical fibre organiser tray as claimed in claim 10, in which the said cooperating guide means further comprise a third guide member shaped to engage with the said second guide member on the said adjacent organiser tray as the said adjacent organiser tray is drawn out towards its access position.

12. An optical fibre organiser tray as claimed in claim 4, in which the said flexible strip or strips is or are so formed that the minimum bend radius of optical fibres lying lengthwise there along is not exceeded as the tray is moved between Its storage and its access positions.

13. An optical fibre organiser tray as claimed in claim 12, in which the or each said curved flexible elongate strip is provided with means for receiving and retaining optical fibres lying along its length.

14. An optical fibre organiser tray as claimed in claim 13, in which the said means for receiving and retaining optical fibres on the or each said flexible elongate strip comprise hook-shape projections extending laterally of the strip on at least one side thereof.
